(19) United States
(12) Patent Application Publication
(10) Pub. No.: US 2006/0108833 A1
(43) Pub. Date: May 25, 2006

(54) Hinged trailor cover with lights

(76) Inventor: John K. Dyer, W. Nottingham, NH (US)

Correspondence Address: BOURQUE & ASSOCIATES, P.A., 835 HANOVER STREET, SUITE 301, MANCHESTER, NH, 03104, US

(21) Appl. No.: 11/258,714

(22) Filed: Oct. 26, 2005

Related U.S. Application Data
(63) Continuation-in-part of application No. 10/994,716, filed on Nov. 22, 2004.

(51) Int. Cl. B62D 25/06

(52) U.S. Cl. 296/185.1

(57) ABSTRACT

A hinged cover for an enclosed trailer features navigational lights secured to the hinged cover. By arranging the navigational lights in the cover, damage to the lights is substantially reduced and visibility of the lights increased. Moreover, the wiring for the lights can be disposed within the internal surface of the cover. This also reduces the likelihood of damaging the wires and increases the accessibility of the wiring.

### CROSS-REFERENCE TO RELATED APPLICATIONS

This application is a continuation-in-part of U.S. application Ser. No. 10/994,716, filed Nov. 22, 2004 and titled Trailer Edge Rail System, which is hereby incorporated fully by reference.

### TECHNICAL FIELD

The present invention relates to trailers and more particularly, relates to trailers having hinged covers with integral lights.

### BACKGROUND INFORMATION

The use of trailers to transport various types of cargo is well known. A common type of trailer 1, FIG. 1, includes a covered trailer such as a snowmobile trailer. Trailers 1 of this type typically have a domed cover 2 that is hingedly connected to a generally flat region 3 at the front 4. As is required by most state and/or federal laws, these trailers 1 also typically include stop and directional lights 5. In the known trailers 1, the lights 5 are typically mounted in the rear of the trailer 1 in either the bumper 8 or frame 9. While this arrangement is generally effective, it suffers from several limitations.

One limitation of the known covered trailers 1 is that the lights 5 are easily damaged. A common method of loading and unloading cargo (for example recreational vehicles such as snowmobiles, personal all terrain vehicles and motorcycles) is to back the trailer 1 up to another object such as a hill or mound of snow or dirt. This facilitates the loading/unloading of the cargo by allowing the cargo to be driven straight onto the cargo area 3 of the trailer 1 (which is otherwise raised above the ground) without the need of ramps or the like.

The trailer 1 must be close enough to the snow bank such that the snowmobile can be easily driven on/off. If the trailer 1 is too far away, then the front of the snowmobile will tend to fall between the trailer 1 and the snow bank. However, if the trailer 1 is too close to the snow bank, then the lights 5 (which are mounted in the lowest part of the trailer 1 in either the bumper 8 or the frame 9) will come into contact with the snow bank resulting in damage or destruction.

Another limitation with the known trailers 1 is that the wiring 7 for the lights 5 is typically run along the bottom 6 of the trailer 1 (generally along the frame 9). This is problematic because it exposes the wiring 7 to the element (snow, ice, dirt, rain, and the like) and to debris coming off the trailer wheels, thereby increasing the likelihood of the wiring 7 being damaged. Moreover, accessing and troubleshooting the wiring 7 is difficult due to the awkward placement of the wiring 7 (especially when the trailer 1 is covered in dirt, mud, snow, rain, or ice).

Accordingly, what is needed is a trailer and trailer cover which minimizes the likelihood of the lights being damaged during loading and unloading. The trailer and trailer cover should also preferably minimize the exposure of the wiring and facilitate the inspection and troubleshooting of the wiring.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### SUMMARY

According to one embodiment, the present invention features a cover for a trailer towed behind a vehicle. The cover includes a shell sized and shaped to cover a cargo region of the trailer. The shell has at least a top and a rear surface. At least one hinge connects the shell to the trailer. In an open position, the shell is positioned such that the cargo area is substantially accessible. In a closed position, the cargo area is substantially inaccessible. At least one light (preferably a navigational light) is secured to the rear surface of the shell, preferably proximate a top region of the rear surface. The light moves with the shell between the open and the closed positions.

Wiring connecting the light to the vehicle is preferably disposed within an interior region of the shell. The shell may additionally include a side surface and a front surface and forms a cavity. An interior light may be disposed within the cavity.

According to another embodiment, the present invention features a trailer for towing behind a vehicle. The trailer includes a frame and a cover. The frame features a tongue having a first end adapted to be secured to the vehicle, a cargo area adapted to support cargo, and at least two wheels. The cover features a top and at least a rear surface, at least one hinge connecting the cover to the frame such that the cover moves between an open position wherein the cargo area is substantially accessible and a closed position wherein the cargo area is substantially inaccessible, and at least one light secured to the rear surface of the cover.

### BRIEF DESCRIPTION OF THE DRAWINGS

These and other features and advantages of the present invention will be better understood by reading the following detailed description, taken together with the drawings wherein:

FIG. 1 is a side view of one embodiment of a prior art enclosed trailer;

FIG. 2 is side perspective view of one embodiment of the trailer cover light system shown in the closed position according to the present invention;

FIG. 3 is side perspective view of one embodiment of the trailer cover light system shown in the open position according to the present invention; and

FIG. 4 is an end view of one embodiment of the trailer cover light system according to the present invention.

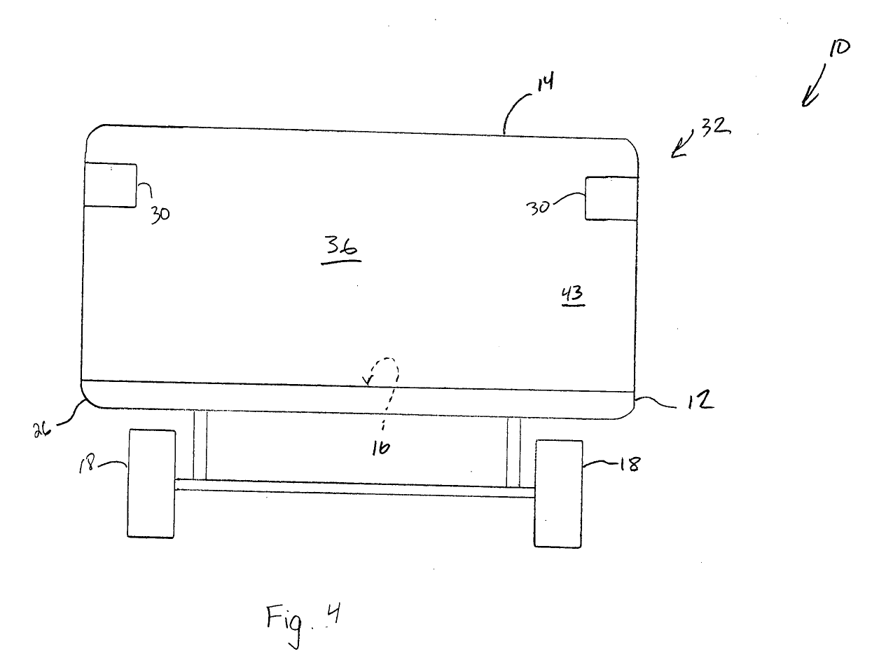

### DETAILED DESCRIPTION OF THE PREFERRED EMBODIMENTS

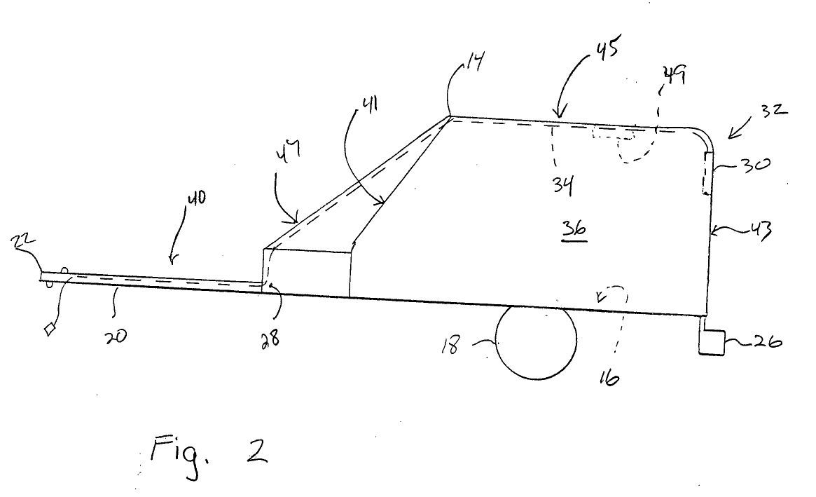

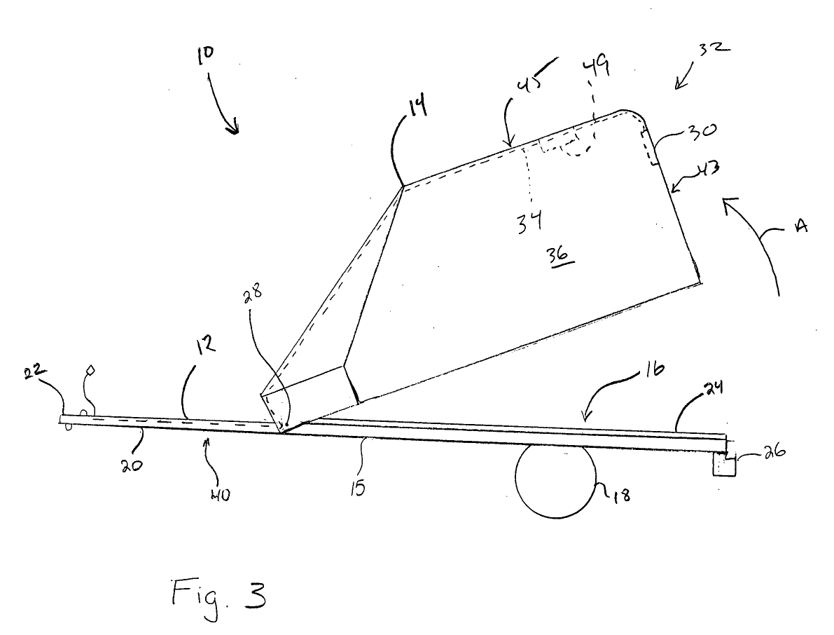

According to one embodiment, the present invention features a trailer cover system 10, FIGS. 2-3, including a trailer 12 and a cover 14. The trailer 12 may feature any trailer design known to those skilled in the art, but preferably includes a frame 15, a cargo area 16, two or more wheels 18, a tongue 20 extending outwards from the cargo area 16, and a mount 22 (such as, but not limited to, a ball and socket type mount) disposed at the proximal end of the tongue 20. According to the exemplary embodiment, the trailer 12 optionally features an edge rail system 24 as described in copending patent application Ser. No. 10/994,716, filed Nov. 22, 2004 and titled Trailer Edge Rail System, which is hereby incorporated fully by reference. The trailer 12 may also feature a bumper 26 secured to a distal end as is well known.

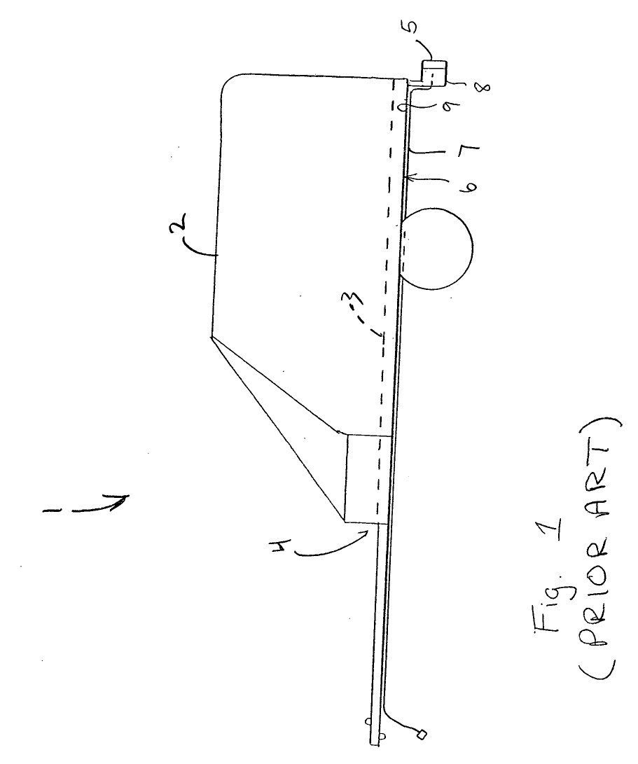

The trailer 12 also features a cover 14. The cover 14 may include any shape known to those skilled in the art including, but not limited to domed, flat, bi-fold, or the like and preferably includes at least one side, top, front and rear surface 41, 45, 47, 43. The cover 14 is connected to the trailer 12 by at least one hinge 28, preferably a single hinge 28 disposed about the proximal end or front surface 47 of the cover 14. The cover 14 moves from a closed position as shown in FIG. 2 wherein the cargo area 16 is substantially covered or inaccessible to an open position as shown in FIG. 3 to facilitate loading and unloading cargo.

Whereas the known trailers 1 (FIG. 1) have heretofore included navigational lights (such as brake lights, turn signal lights, and back-up lights) mounted low in either the frame or the bumper, the present invention features lights 30 mounted or secured to the cover 14. The lights 30 preferably include navigational lights, but may also include running lights secured to one or more sides 41. At least the navigational lights 30 are secured to the rear surface 43, preferably proximate the upper or top region 32 of the cover 14.

In contrast to the known trailers 1, the wiring 34 that supplies the necessary power and/or signals to the lights 30 from the tow vehicle (not shown) is preferably disposed within an interior region or cavity 36 formed by the cover 14. The present invention may also incorporate interior lights 49 disposed within the interior region 36.

The present invention provides several unexpected benefits. For example, mounting the lights 30 within the cover 14 significantly reduces the likelihood of damaging the lights 30 while backing up the trailer 10 to another object such as, but not limited to, a mound of snow, dirt, hill, or the like. One reason for this is because the cover 14 can be raised prior to backing up the trailer 10 thereby moving the lights 30 away from the rear of the trailer 10. Typically the hinge 28 is arranged about the proximate end of the cover 14 such that the cover 14 swings upwards and towards the tow vehicle in the direction of arrow A as shown in FIG. 3. As a result, the lights 30 are moved upwards and behind the vertical plane of the trailer 10. Thus, the rear of the trailer 10 is more likely to contact the mound of snow than the lights 30.

Additionally, even if the cover 14 is in the closed position shown in FIG. 2, the lights 30 can be mounted near the top region 32 of the cover 14. In most situations, the base of the mound of snow extends outwardly further than the top of the mound. Consequently, when the user backs the trailer 1 up to the mound of snow, the bottom rear or bumper 26 of the trailer 10 is more likely to come into contact with the mound of snow prior to top region 32 of the cover.

Because the lights 30 according to the present invention are less likely to be damaged, the present invention greatly facilitates the loading and unloading process. In practice, the user can simply back up to the mound of snow slowly until the rear or bumper 26 comes into contact with the mound of snow without fear of braking the lights 30. Additionally, the visibility of the lights 30 is significantly increased because the lights 30 can be mounted higher. Having the lights 30 mounted higher allows the lights 30 to be more easily seen behind and reduces the amount of debris (such as snow, slush, mud and the like) from building up on the lights 30 as the trailer 10 is driven down the road.

Another unexpected benefit of the present invention is that the wiring 34 is protected from the environment and debris and is significantly easier to access and troubleshoot. As mentioned above, the known trailers 1 (FIG. 1) typically run the wiring along the bottom of the trailer 1. As a result, the wiring is exposed to the environment and debris (especially debris from the wheels), significantly increasing the likelihood of damaging the wiring. Furthermore, one must crawl under the trailer 1 in order to access and troubleshoot the wiring. This is particularly undesirable, especially if the trailer 1 is covered in rain, mud, snow, or ice.

In contrast, most of the wiring 34 according to the present invention is disposed within the interior cavity 36 formed by the cover 14. As a result, this wiring 34 is protected from the environment and debris and is significantly less likely to be damaged. Moreover, in the event the wiring 34 needs to be serviced, the wiring 34 is easily accessible without having to crawl under the trailer 10.

The wiring 34 preferably exits the cover 14 proximate the hinge 28. In the preferred embodiment, the wiring 34 includes a sufficient amount of extra wiring to allow the wiring 34 to move/bend about the hinge 28. The wiring 34 may also be encased in a protective covering. The region 40 of the wiring 34 outside of the cover 14 may be either run along a side of the tongue 20 or alternatively may be disposed within an interior portion of the tongue 20.

As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. A cover for a trailer towed behind a vehicle, said cover comprising:
a shell sized and shaped to cover a cargo region of said trailer, said shell having at least a top and a rear surface;
at least one hinge connecting said shell to said trailer wherein said shell includes an open position wherein said cargo area is substantially accessible and a closed position wherein said cargo area is substantially inaccessible; and
at least one light secured to said rear surface of said shell, wherein said light moves with said shell between said open and said closed positions.

2. The cover as claimed in claim 1 wherein said at least one light includes at least one navigational light.

3. The cover as claimed in claim 2 wherein said at least one light is disposed proximate a top region of said rear surface of said shell.

4. The cover as claimed in claim 1 further including wiring connecting said at least one light to said vehicle.

5. The cover as claimed in claim 4 wherein at least a portion of said wiring is disposed within an interior region of said shell.

6. The cover as claimed in claim 1 wherein said shell further includes a side surface and a front surface, wherein said shell forms a cavity.

7. The cover as claimed in claim 6 further including at least one interior light disposed within said cavity.

8. A trailer for towing behind a vehicle, said trailer comprising:
a frame including:
a tongue having a first end adapted to be secured to said vehicle;
a cargo area adapted to support cargo; and
at least two wheels; and
a cover, said cover including:
a top and at least a rear surface, said rear surface arranged substantially opposite said tongue;
at least one hinge connecting said cover to said frame such that said cover moves between an open position wherein said cargo area is substantially accessible and a closed position wherein said cargo area is substantially inaccessible; and
at least one light secured to said rear surface of said cover.

9. The trailer as claimed in claim 8 wherein said at least one light includes at least one navigational light.

10. The trailer as claimed in claim 9 wherein said at least one navigational light is disposed proximate a top region of rear surface of said cover.

11. The trailer as claimed in claim 10 further including wiring adapted to connect said at least one navigational light to said vehicle.

12. The trailer as claimed in claim 11 wherein at least a portion of said wiring is disposed within an interior region of said cover.

13. The trailer as claimed in claim 8 wherein said cover further includes at least one side surface and front surface, wherein said cover forms a cavity.

14. The trailer as claimed in claim 13 further including at least one interior light disposed within said cavity.

15. A cover for a trailer to be towed behind a vehicle, said cover comprising:
a shell forming an internal cavity, said shell having a rear surface;
a hinge adapted to connect said shell to said trailer such that said cover moves between an open and a closed position;
at least one navigational light secured to said rear surface of said shell; and
at least one wire adapted to connect said at least one navigational light to said vehicle wherein at least a portion of said at least one wire is disposed within said internal cavity.

16. The cover as claimed in claim 15 wherein said at least one navigational light is disposed proximate a top region of said rear surface of said shell.

17. The trailer as claimed in claim 15 further including at least one interior light disposed within said cavity.

18. The trailer as claimed in claim 15 further including running lights secured to said shell.
